(19) United States
(12) Patent Application Publication
(10) Pub. No.: US 2025/0233249 A1
(43) Pub. Date: Jul. 17, 2025

(54) RECHARGEABLE ENERGY STORAGE SYSTEM WITH CELL AND CELL HOLDER ASSEMBLY WITH MECHANICALLY INTERLOCKING INTERFACES

(71) Applicant: GM GLOBAL TECHNOLOGY OPERATIONS LLC, Detroit, MI (US)

(72) Inventors: Mohammad Hamza KIRMANI, Troy, MI (US); Gary L. JONES, Farmington Hills, MI (US); Chinmaya PATIL, South Lyon, MI (US); Mark A. KRAMARCZYK, Sterling Heights, MI (US); Anthony Michael COPPOLA, Rochester Hills, MI (US); Tito R. HUFFMAN, Eastpointe, MI (US); Velmurugan AYYANAR, Pondicherry (IN); Madhu Lal THACHARODY, Kozhikode (IN); William Thomas KUCINSKI, Windsor (CA); Xiaosong HUANG, Novi, MI (US); David J. BROOKS, Troy, MI (US)

(21) Appl. No.: 18/410,914

(22) Filed: Jan. 11, 2024

(51) Int. Cl. H01M 50/244; H01M 50/186; H01M 50/193; H01M 50/209; H01M 50/213; H01M 50/264

(52) U.S. Cl. CPC H01M 50/244; H01M 50/186; H01M 50/193; H01M 50/209; H01M 50/213; H01M 50/264

(57) ABSTRACT

A rechargeable energy storage system includes a cell holder tray including a plurality of battery interlocking features, wherein the cell holder tray includes a plurality of vent passages through the cell holder tray and the cell holder tray includes a plurality of vent channels below the vent passages. A plurality of battery cells are each joined to a respective one of the battery interlocking features above one of the vent passages in the cell holder tray, wherein the plurality of battery cells are encapsulated in a polymer potting.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to rechargeable energy storage system with cell and cell holder assembly with mechanically interlocking interfaces.

Previously, battery packs have been provided with a venting system that allows the venting of individual battery cells while isolating the venting gasses from the remaining battery cells within the pack. The vent system must remain open for gas to traverse during a thermal event so that the gas must be able to reach the pack's vent port. The rest of the battery pack can be filled with potting resin (foamed or non-foamed) for electrical isolation, structural performance, and thermal insulation of the battery cells. Locating the cells on the cell holder is currently challenging for the battery pack assembly. Further, controlling the potting from leaking into the vent channel is challenging.

### SUMMARY

A rechargeable energy storage system includes a cell holder tray including a plurality of battery interlocking features. A plurality of battery cells are each joined to a respective one of the battery interlocking features of the cell holder tray.

According to a further aspect, the battery interlocking features include protrusions to guide the cell into their positions on the cell holder and have mechanical interlock features that engage with the cells to mechanically lock them after assembly.

According to a further aspect, an adhesive secures the plurality of battery cells to the cell holder tray.

According to a further aspect, the plurality of battery interlocking features form a watertight seal between the plurality of battery cells and the cell holder tray.

According to a further aspect, a flame-retardant elastomer seals a space between the plurality of battery cells and the cell holder tray.

According to a further aspect, the plurality of battery interlocking features include a snap fit with the plurality of battery cells.

According to a further aspect, the cell holder includes three snap features around each of the plurality of battery cells.

According to a further aspect, the snap fit holds onto a seam of the plurality of battery cells and pulls them down towards the cell holder tray.

According to a further aspect, the plurality of battery interlocking features include at least one of a chamfered or stepped wall to guide the plurality of battery cells in their location.

According to a further aspect, the interlocking features include a deflecting part.

According to a further aspect, the interlocking features engage sides of the plurality of battery cells.

According to a further aspect, the interlocking features engage bottoms of the plurality of battery cells.

According to a further aspect, the interlocking features engage sides and bottoms of the plurality of battery cells.

According to a further aspect, the cell holder tray includes a plurality of vent channels under the cells.

According to a further aspect, the plurality of battery cells are cylindrical.

According to a further aspect, the plurality of battery cells are prismatic.

According to a further aspect, the plurality of battery cells are encapsulated in a polymer potting.

According to a further aspect, the cell holder tray includes an upper tray and a lower tray.

According to a further aspect, at least one of the upper tray and the lower tray is made from one of nylon, polycarbonate and polypropylene.

According to another aspect of the present disclosure, a rechargeable energy storage system includes a cell holder tray including a plurality of battery interlocking features, wherein the cell holder tray includes a plurality of vent passages through the cell holder tray and the cell holder tray includes a plurality of vent channels below the vent passages. A plurality of battery cells are each joined to a respective one of the battery interlocking features above one of the vent passages in the cell holder tray, wherein the plurality of battery cells are encapsulated in a polymer potting.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic view of a battery cell holder assembly with mechanically interlocking interfaces according to the principles of the present disclosure;

FIGS. 2A and 2B are side and plan schematic views of a mechanical interlocking interface during assembly of a battery therein;

FIGS. 3A and 3B are side and plan schematic views of a battery installed in a mechanical interlocking interface;

FIG. 4 is a schematic view of a battery cell holder assembly with mechanically interlocking interfaces according to a second embodiment of the present disclosure;

FIG. 5 is a perspective view of the battery cell holder assembly according to the second embodiment;

FIG. 6 is a schematic view of a battery cell holder assembly with mechanically interlocking interfaces according to a third embodiment of the present disclosure;

FIG. 7 is a perspective view of a battery cell holder assembly with mechanical interlocking interfaces according to the fourth embodiment of the present disclosure;

FIG. 8 is a cross-sectional view of a battery cell holder assembly with mechanically interlocking interfaces according to the fourth embodiment of the present disclosure;

FIG. 9 is a perspective view of a battery cell holder assembly with alignment bores according to the fifth embodiment of the present disclosure; and

FIG. 10 is a cross-sectional view of a battery cell holder assembly with alignment bores according to the fifth embodiment of the present disclosure.

In the drawings, reference numbers may be reused to identify similar and/or identical elements.

### DETAILED DESCRIPTION

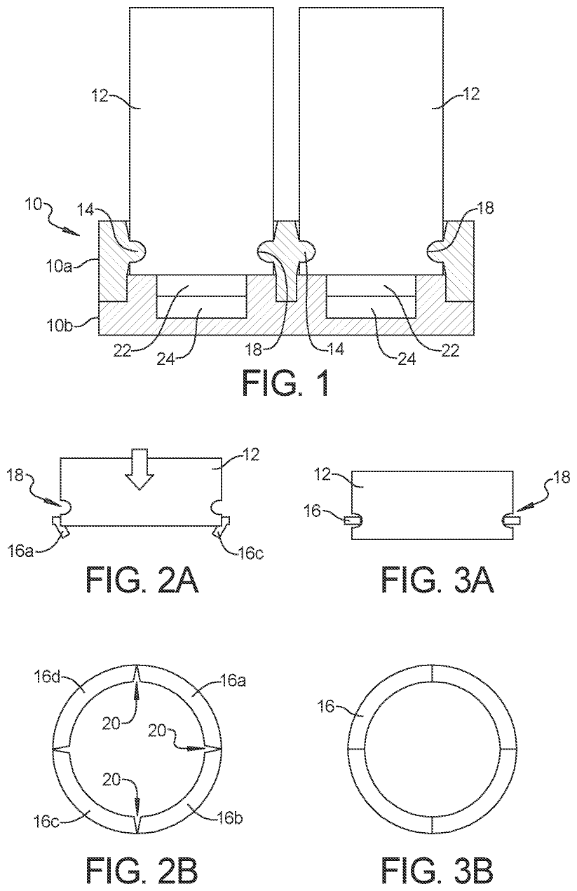

With reference to FIGS. 1, 2A-2B and 3A-3B, a portion of a battery cell holder tray 10 is shown for supporting a plurality of battery cells 12 within a battery module. The cell holder tray 10 includes a plurality of battery interlocking features 14. The battery interlocking features 14 can include a generally annular snap ring 16 that is engageable with an annular recess 18 provided in a wall surface of the plurality of battery cells 12. With reference to FIG. 2B, the generally annular snap ring 16 can include a plurality of slots 20 that allow flexibility of the snap ring segments 16a-16d to flex away from one another during insertion of a battery cell as illustrated in FIG. 2A. As shown in FIGS. 3A and 3B, when the snap ring 16 is fully received within the annular recess 18 in the battery cells 12, the snap ring 16 returns to its original shape as shown in FIG. 3B. As shown in FIG. 1, the cell holder tray 10 can be formed of an upper tray portion 10a and a lower tray portion 10b. the upper tray 10a can define the battery interlocking features 14 and the lower tray 10b can define a plurality of vent passages 22 that are each in communication with a vent of the battery cells 12 and a plurality of channels 24 that are in communication with the vent passages 22

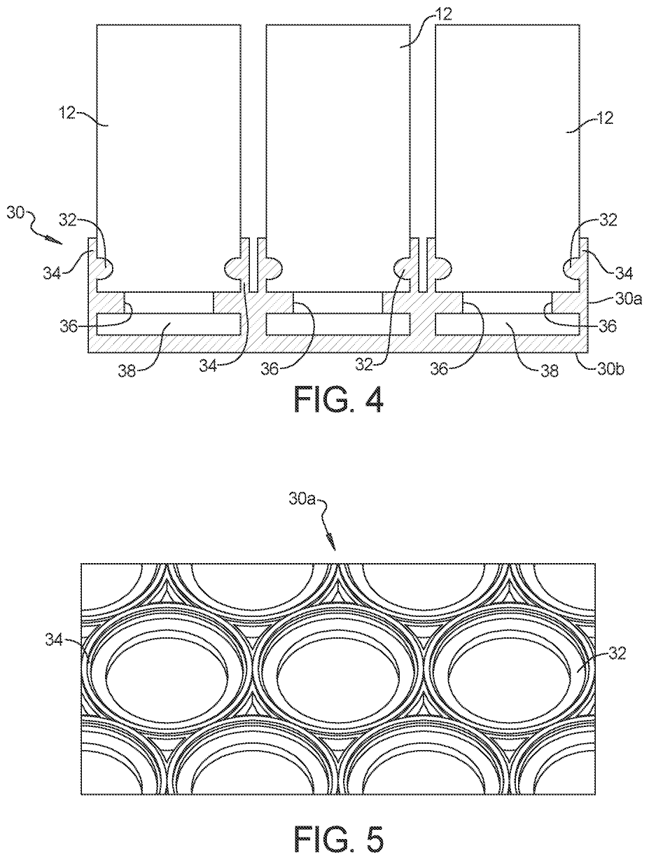

It should be noted that the battery interlocking features 14 can take on alternative forms. With reference to FIGS. 4 and 5, the battery cell holder tray 30 includes interlocking features 14 that include snap-in features 32 that are supported on flexible sidewalls 34 that receive the battery cells 12. During insertion of the battery cells 12, the sidewalls 34 are able to flex outward to allow the battery cells 12 to be inserted until the snap-in features 32 align with the annular recess 20 in the battery cells 12. In which case, the snap-in features 32 engage the annular recess 20 and the flexible sidewalls 34 return toward their undeformed state. The sidewalls 34 can be segmented to provide additional flexibility or it can be continuous around each battery cell 12. As shown in FIG. 4, the battery cell holder tray 30 includes upper tray portion 30a that define vent passages 36 for each battery cell and a lower tray portion 30b for combining with the upper tray portion 30a to define vent channels 38 below the vent passages 36. FIG. 5 shows a perspective view of the upper tray portion 30a with an array of the flexible sidewalls 34 encircling the vent passages 36.

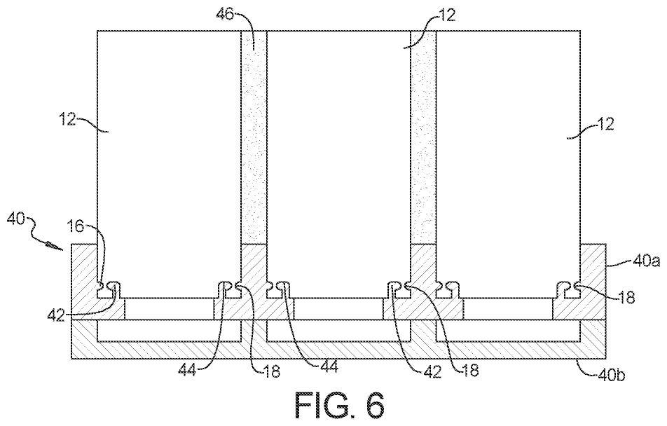

With refence to FIG. 6, a battery cell holder tray 40 is shown that include battery interlocking features 14 can include a generally annular snap ring 16 that is engageable with an annular recess 18 provided in a wall surface of the plurality of battery cells 12. In addition, the battery cell holder tray 40 further include interlocking features 42 that engage an annular recess 44 in the bottom of the battery cells 12. FIG. 6 also illustrates potting 46 encapsulating the battery cells 12.

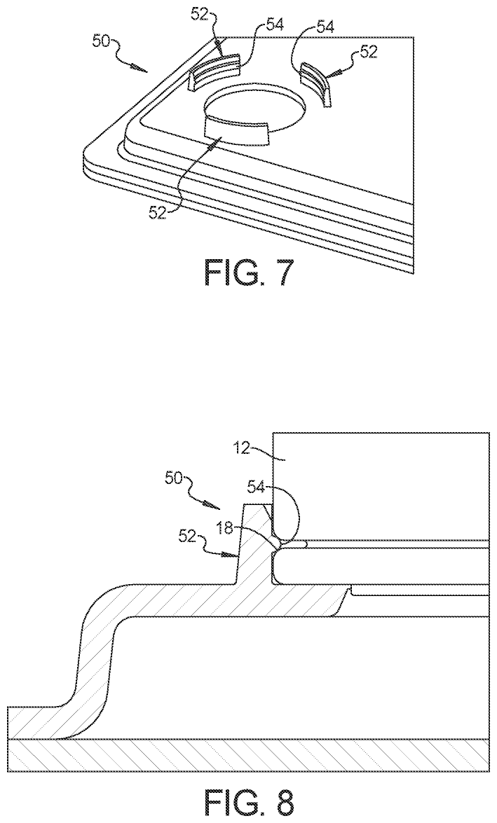

With reference to FIGS. 7 and 8, a battery cell holder tray 50 is shown that includes segmented interlocking features 52 for engaging an annular recess 18 provided in a wall surface of the plurality of battery cells 12. The segmented interlocking features 52 can include two or more partial circular segments that include a rib 54 that is engageable with the annular recess 18 in the battery cells 12.

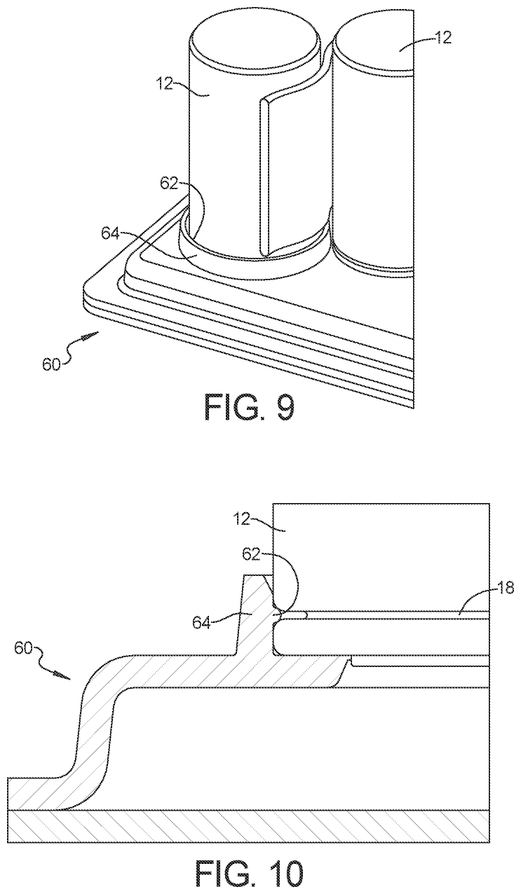

With reference to FIGS. 9 and 10, a battery cell holder tray 60 is shown that includes battery alignment bores 62 in the form of a wall structure 64 that guides and surrounds the battery cells 12 instead of snap features. The alignment bores 62 are strategically placed to accurately locate the battery cells 12 across the cell holder tray during assembly.

The interlock features and other systems of the present disclosure allow the battery cells to self-locate during the assembly process and mechanically lock the cells to the cell tray to provide a more robust joining of the cells to the cell tray and to prevent potting from leaking into the vent channels. It is noted that adhesives and/or sealants can further be used to secure the battery cells 12 to the cell holder tray. The sealant along with the interlock features can prevent potting that is encapsulated around the battery cells from entering the vent passages and/or vent channels. The battery cells holder trays of the present application can be formed by molding, 3-D printing and/or multipiece construction. The cell holder trays can be made from plastic materials including but not limited to nylon, polycarbonate and polypropolene. The plastic materials can further contain filler materials, such as, but not limited to flame retardants, glass fiber, glass bubble, etc.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A rechargeable energy storage system, comprising:
a cell holder tray including a plurality of battery interlocking features; and
a plurality of battery cells each joined to a respective one of the battery interlocking features of the cell holder tray.

2. The rechargeable energy storage system according to claim 1, wherein the battery interlocking features include protrusions to guide the cell into their positions on the cell holder and have mechanical interlock features that engage with the cells to mechanically lock them after assembly.

3. The rechargeable energy storage system according to claim 1, further comprising an adhesive securing the plurality of battery cells to the cell holder tray.

4. The rechargeable energy storage system according to claim 1, wherein the plurality of battery interlocking features form a watertight seal between the plurality of battery cells and the cell holder tray.

5. The rechargeable energy storage system according to claim 1, further comprising a flame-retardant elastomer sealant between the plurality of battery cells and the cell holder tray.

6. The rechargeable energy storage system according to claim 1, wherein the plurality of battery interlocking features include a snap fit with the plurality of battery cells.

7. The rechargeable energy storage system according to claim 6, wherein the cell holder includes three snap features around each of the plurality of battery cells.

8. The rechargeable energy storage system according to claim 6, wherein the snap fit holds onto a seam of the plurality of battery cells and pulls them down towards the cell holder tray.

9. The rechargeable energy storage system according to claim 6, wherein the plurality of battery interlocking features include at least one of a chamfered or stepped wall to guide the plurality of battery cells in their location.

10. The rechargeable energy storage system according to claim 1, wherein the interlocking features include a deflecting part.

11. The rechargeable energy storage system according to claim 1, wherein the interlocking features engage sides of the plurality of battery cells.

12. The rechargeable energy system according to claim 1, wherein the interlocking features engage bottoms of the plurality of battery cells.

13. The rechargeable energy storage system according to claim 1, wherein the interlocking features engage sides and bottoms of the plurality of battery cells.

14. The rechargeable energy storage system according to claim 1, wherein the cell holder tray includes a plurality of vent channels under the cells.

15. The rechargeable energy storage system according to claim 1, wherein the plurality of battery cells are cylindrical.

16. The rechargeable energy storage system according to claim 1, wherein the plurality of battery cells are prismatic.

17. The rechargeable energy storage system according to claim 1, wherein the plurality of battery cells are encapsulated in a polymer potting.

18. The rechargeable energy storage system according to claim 1, wherein the cell holder tray includes an upper tray and a lower tray.

19. The rechargeable energy storage system according to claim 18, wherein at least one of the upper tray and the lower tray is made from one of nylon, polycarbonate and polypropylene.

20. A rechargeable energy storage system, comprising:
a cell holder tray including a plurality of battery interlocking features, wherein the cell holder tray includes a plurality of vent passages through the cell holder tray and the cell holder tray includes a plurality of vent channels below the vent passages; and
a plurality of battery cells each joined to a respective one of the battery interlocking features of the cell holder tray, wherein the plurality of battery cells are encapsulated in a polymer potting.
